(19) United States
(12) Patent Application Publication
(10) Pub. No.: US 2005/0250371 A1
(43) Pub. Date: Nov. 10, 2005

(54) Sealing structure for connector

(75) Inventor: Kazuhiko Koga, Toyohashi-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/119,701

(22) Filed: May 3, 2005

(30) Foreign Application Priority Data
May 7, 2004 (JP) 2004-138932

(51) Int. Cl. H01R 4/24

(52) U.S. Cl. 439/395

(57) ABSTRACT

A connector having insulation for electrical connection includes a housing having a concave portion, a terminal insert-molded in the housing, a lead wire electrically coupled with the terminal, a potting material for sealing the concave portion and an insulation material. The connector uses the insulation material in contact with the potting material to cover an end of the terminal extending upward in the concave portion.

### CROSS REFERENCE TO RELATED APPLICATION

This application is based on and claims the benefit of priority of Japanese Patent Application No. 2004-138932 filed on May 7, 2004, the disclosure of which is incorporated herein by reference.

### FIELD OF THE INVENTION

The present invention relates to a sealing structure of a connector and, more specifically to a sealing structure of a terminal portion of a connector.

### BACKGROUND OF THE INVENTION

A connector portion of an electrical device such as a pressure sensor is physically affected by external conditions of temperature change combined with a splash of water or the like. A connector having a terminal used in a conventional pressure sensor is shown in FIG. 10. In this figure, a terminal 101 is embedded in a housing 100. A left end of the terminal 101 is protruding from a left face of the housing 100 and is electrically connected to a pressure sensor chip 102. A right end of the terminal 101 is protruding from the housing 100 into a connection space 103 and is connected to a lead wire 110 by a solder 111. The terminal 101 is sealed in the connection space 103 by a sealing material 112 and is protected from a splash of water or the like.

The sealing material 112 made of resin securely covers the terminal 101 when a sufficient depth d from the top end of the terminal 101 to an upper surface thereof is reserved. However, restriction on the size of the pressure sensor or the like prohibits a reservation of the sufficient depth d in the connection space. 103. When the depth d is not sufficient, the sealing material 112 has a crack 120 as shown in FIG. 11 caused by an iterated heat stress, or the end of the terminal 101 protrudes from the surface of the sealing material 112 as shown in FIG. 12 because of an insufficiency of the sealing material 112. In these cases, the splash of water on the end of the terminal 101 induces a leak current, an erroneous output of the pressure sensor or the like, and leads to corrosion of the terminal 101 and the like.

### SUMMARY OF THE INVENTION

In view of the above-described problems, it is an object of the present invention to provide a sealing structure of a terminal portion of a connector that securely seals a terminal from external disturbance.

The sealing structure of the present invention is characterized by an end of a terminal having an insulation covering in a connection space filled with a sealing material. In this structure, the end of the terminal is securely covered by the covering in the connection space even when the surface of the sealing material has a crack caused by aging or the like. That is, the end of the terminal extending upward is protected by an insulation covering from being exposed from the sealing material when the sealing material is damaged on its surface, or the amount of the sealing material is insufficient.

The insulation covering of the terminal may be a cap member that is put on the end of the terminal with the end inserted therein. The end of the terminal can easily be insulated when the covering is in a shape of a cap.

The insulation covering of the terminal may have convex portions and concave portions on an outer circumferential surface. The insulation covering of the terminal has a wider contact area with the sealing material in this manner.

The insulation covering of the terminal may have a flange on the cap member. The insulation covering is firmly fixed in the sealing material in this manner.

The insulation covering of the terminal may integrally cover plural ends of the terminals when there are plural ends of the terminals in the connection space. The insulation covering can easily be disposed on the plural ends of the terminals when single body of the insulation covering covers the plural ends of the terminal.

The insulation covering of the terminal may be a coating. The coating can easily cover the end of the terminal.

### BRIEF DESCRIPTION OF THE DRAWINGS

Other objects, features and advantages of the present invention will become more apparent from the following detailed description made with reference to the accompanying drawings, in which:

FIG. 1 is a vertical cross-sectional view of a pressure sensor according to a first embodiment of the present invention;

FIG. 2 is a top view of a connector side housing of the pressure sensor shown in FIG. 1 including a lead wire and its connecting portion;

FIG. 3 is a top view of a cap member;

FIG. 4 is a cross-sectional view of the cap member shown in FIG. 3 along the IV-IV line;

FIG. 5 is a cross-sectional view of the pressure sensor for an illustration of manufacturing steps;

FIG. 6 is a cross-sectional view of the pressure sensor for an illustration of manufacturing steps;

FIG. 7 is a top view of a connector side housing of the pressure sensor according to a second embodiment;

FIG. 8 is a cross-sectional view of the housing shown in FIG. 7 along the VIII-VIII line;

FIG. 9 is a cross-sectional view of the connector side housing according to other embodiment;

FIG. 10 is a cross-sectional view of a pressure sensor for an illustration of a background of the invention;

FIG. 11 is a cross-sectional view of the connector side housing for an illustration of a problem in a conventional connector; and

FIG. 12 is a cross-sectional view of the connector side housing for an illustration of a problem in a conventional connector.

### DETAILED DESCRIPTION OF THE PREFERRED EMBODIMENTS

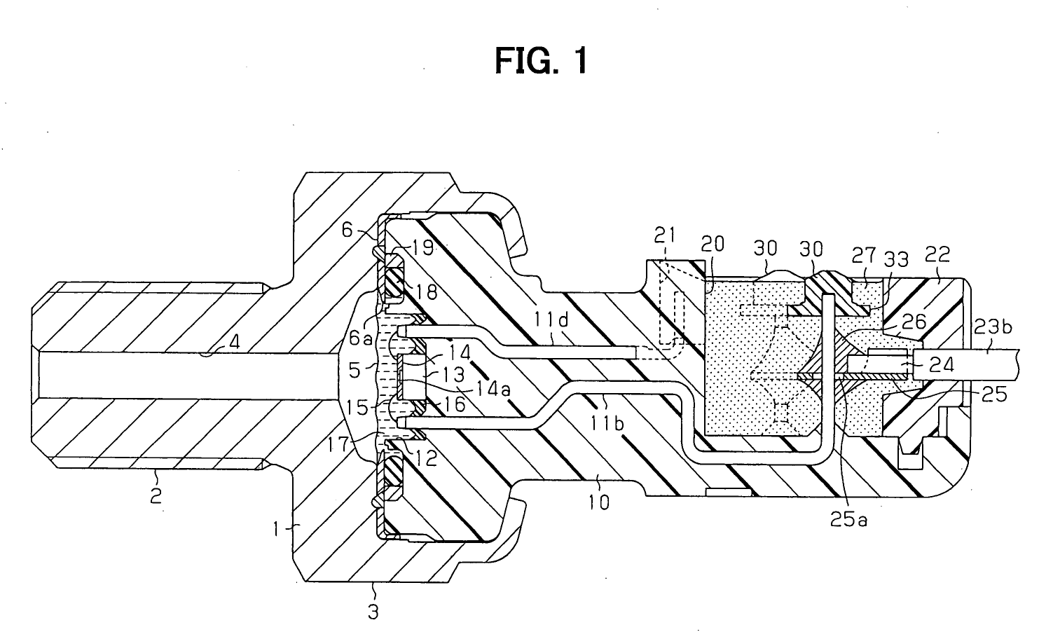

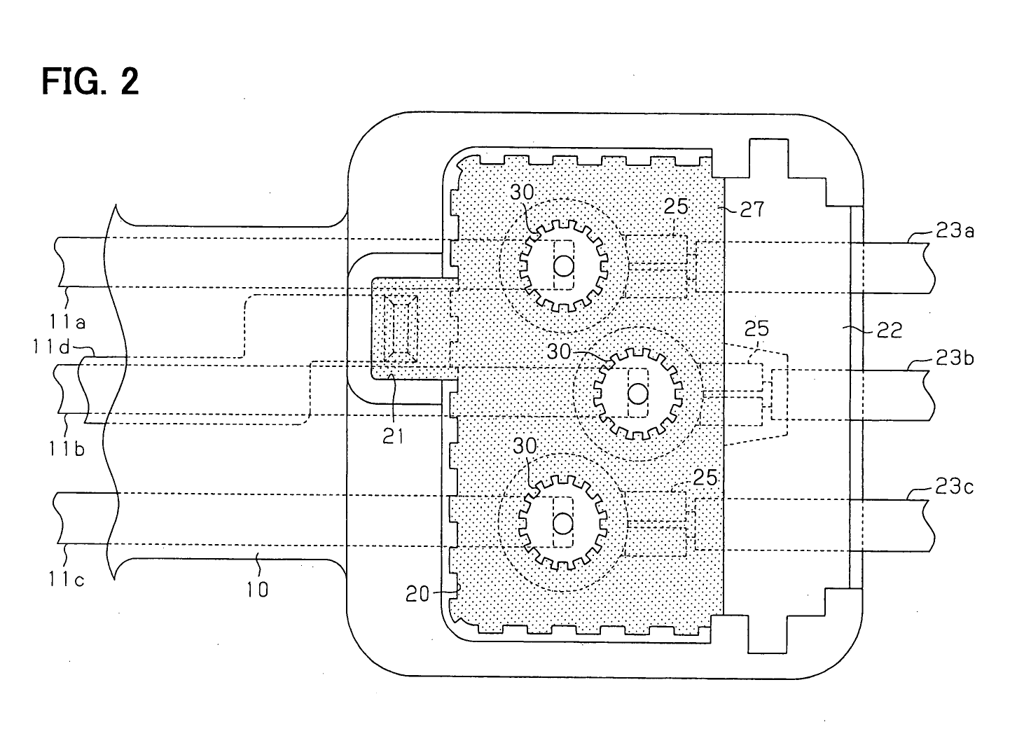

A vertical cross-sectional view of a pressure sensor according to a first embodiment of the present invention is shown in FIG. 1. The pressure sensor includes a pressure introduction housing 1 made of metal and a connector side housing 10 made of resin. Lead wires 23a, 23b and 23c on the right side of the connector side housing 10 and their connecting portions are shown in FIG. 2. This pressure sensor is used on an automobile for detecting fluid pressure such as a fuel pressure, an engine oil pressure or the like. Detected pressure of those fluids is translated to an electric voltage output.

In FIG. 1, the pressure introduction housing 1 is generally in a cylindrical shape having a laterally extending body. The pressure introduction housing 1 has a screw portion on its left of an outer surface for fixing the body. The housing 1 has a six-sided bolt portion 3 on its right of the outer surface. The pressure introduction housing 1 has a through hole 4 aligned on its axis for introducing pressure. A diaphragm 5 is pressed and laser-welded to a plate 6 having a hole 6a at a center thereof on one end of the through hole 4. An opening on one end of the through hole 4 is hermetically closed in this manner.

The connector side housing 10 is generally in a cylindrical shape having a laterally extending body. The connector side housing 10 has a left face abutted to and caulked by a right face of the pressure introduction housing 1.

The connector side housing 10 has pins 11a, 11b, 11c and 11d embedded therein as connector terminals. The pins 11a, 11b, 11c and 11d are insert-molded in the housing 10. The pins 10a, 10b, 10c and 10d are made of brass. The pins 11a, 11b and 11c are used for pressure detection and the pin 11d is used for inspection. The connector side housing 10 has a concave portion 12 on the left face, and left ends of the pins 11a, 11b, 11c and 11d protrude from a bottom of the concave portion 12.

A pedestal 13 is disposed at the bottom of the concave portion 12, and a sensor chip 14 is fixed on the pedestal 13. The sensor chip 14 has a concave portion that is formed in a decreased thickness serving as a diaphragm 14a. A space defined by the concave portion of the sensor chip 14 and the pedestal 13 works as a standard pressure space (e.g., a vacuum space). The diaphragm 14a has four gauges (impurity diffused layer). The four gauges are connected to implement a full-bridge circuit. The diaphragm 14a is warped by a difference of pressures on both sides thereof, and piezoresistance effect of the warpage of the diaphragm 14a changes resistance of each gauge (impurity diffused layer). The change in resistance is detected by the full-bridge circuit. That is, a difference of voltage between two terminals of the full-bridge circuit is detected as an output of an electric signal when a predetermined amount of electric current is applied between the other two terminals of the full-bridge circuit. An amplifier formed as a signal processing circuit on the sensor chip 14 takes the difference of voltage between the two terminals outputted from the full-bridge circuit as an input signal. The input signal is amplified to be an output of the amplifier.

The sensor chip 14 and ends of the pins 11a, 11b, 11c and 11d are bonded by using aluminum wires 15 for a constant current supplied to the sensor chip 14 and the output of the electric signal from the sensor chip 14. Protruding portions of the pins 11a, 11b, 11c and 11d are sealed at the bottom of the concave portion 12 by a sealant 16. The pressure introduction housing 1 and the connector side housing 10 are caulked to contain an oil 17 in the concave portion 12 with the diaphragm 5 hermetically sealing an opening of the concave portion 12. The oil 17 is hermetically sealed in a space defined by the diaphragm 5 and the connector side housing 10 in the following manner. That is, pouring the oil 17 in the space first, and the connector side housing 10 is caulked by the pressure introduction housing 1 with an O ring 18 and a backup ring 19 in vacuum.

The connector side housing 10 has a connection space 20 formed on the right end. An upper portion and a right side face of the connection space 20 are formed as openings. The pins 11a, 11b and 11c protrude from a bottom of the connection space 20 and extend in an upper direction. More specifically, the pins 11a, 11b and 11c extend vertically upward. The connection space 20 has a side space 21 (a concave space) formed on the left. The depth of the side space 21 is smaller than the connection space 20. The pin 11d protrudes from a bottom of the side space 21 and extends upward.

A grommet 22 is inserted in an opening on the right side of the connection space 20 of the connector side housing 10. The opening is covered by the grommet 22. The ends of lead wires 23a, 23b and 23c extend through the grommet 22 hermetically. Each of cable cores 24 of the lead wires 23a, 23b and 23c has a contact 25 (a metal fitting) caulked thereon. Each of the contact has a through hole 25a, and pins 11a, 11b and 11c are inserted in the holes 25a. The contacts 25 and the pins 11a, 11b and 11c are connected by using a solder 26. The connection space 20 has insulation 27 contained therein with the grommet 22 inserted in the connection space 20. The insulation 27 is hardened to seal the inside of the connection space 20, that is, the pins 11a, 11b and 11c with its soldered portions, the lead wires 23a, 23b and 23c, and contacts 25 are sealed. In this manner, the inside of the connection space 20 is protected from foreign matter such as water and the like. The insulation 27 is made of epoxy. The pin 11d in the side space 21 is also sealed by the insulation 27.

The connector side housing 10, as described above, holds the pins 11a, 11b and 11c as terminals with their ends protruding in the connection space 20, and the connection space 20 holds the pins 11a, 11b and 11c, and lead wires 23a, 23b and 23c electrically connected at their ends and sealed by the hardened insulation 27.

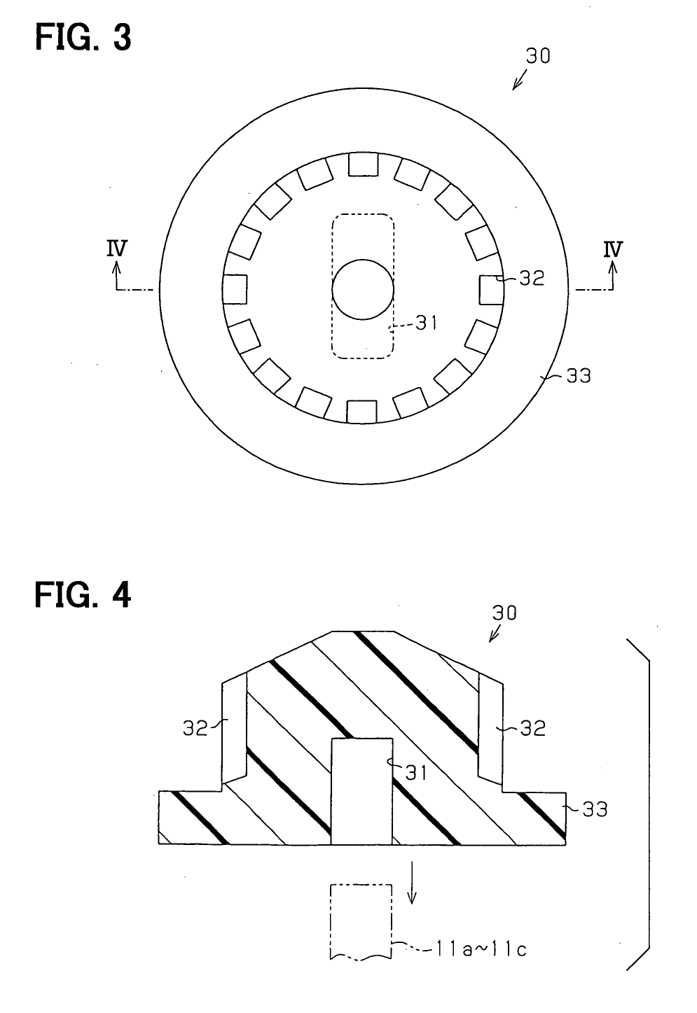

Further, each of the pins 11a, 11b and 11c has a cap member 30 for insulation on its end extending upward in the connection space 20. That is, each end of the pins 11a, 11b and 11c is inserted in the cap member 30 that serves as an insulating cover. FIG. 3 shows a top view of the cap member 30, and FIG. 4 shows a vertical cross-sectional view of the cap member 30 along IV-IV line in FIG. 3.

The cap member 30 shown in FIGS. 3 and 4 is made of resin. The cap member 30 is generally in a cylindrical pillar shape, and has a hole 31 as a receptacle of the ends of the pins 11a, 11b and 11c at the center of the bottom surface. An outer surface of the cap member 30 has many vertically extending concavities and convexities 32 on an entire outer circumference. The cap member 30 has a flange 33 on the entire outer circumference of the lower portion for preventing the cap member 30 from coming off from the pins 11a, 11b and 11c.

The cap member 30 shown in FIGS. 3 and 4 is put on the ends of the pins 11a, 11b and 11c as shown in FIG. 1, and the insulation 27 fills the connection space 20 to a height just below a top end of the cap member 30. The concavities and convexities 32 on the outer surface of the cap member 30 expand a contact area of the insulation 27 on the cap member 30. The expanded area of contact between the insulation 27 and the cap member 30 prevents the insulation 27 from exfoliating. The flange 33 on the outer surface of the cap member 30 prevents the cap member 30 from coming off. Further, the concavities and convexities 32 combined by the flange 33 on the cap member 30 benefit the tightness of seal of the insulation 27 by extending a contact surface between the insulation 27 and the cap member 30 from outside atmosphere to the pins 11a, 11b and 11c.

The material of the cap member 30 is an electric insulation material and is high in adhesiveness with the insulation 27. The cap member 30 may easily be formed by using a resin material having thermal plasticity. The material may also be a resin material such as polybutyleneterephtalate (PBT), polyphenylene sulfide (PPS) or the like. The material may also be a rubber such as acrylic rubber, nitrile rubber or the like, or may also be a ceramic type material. The material may preferably have a similar thermal expansion coefficient to a material of the insulation 27 for the tightness of sealing.

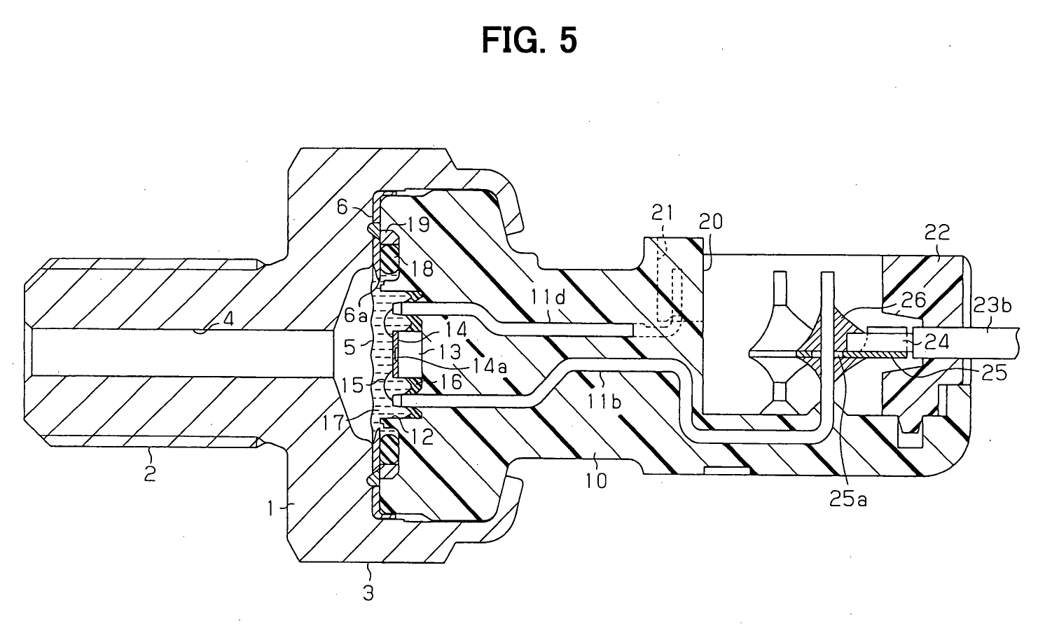

Manufacturing steps of the pressure sensor is described with reference to FIGS. 5, 6 and 1 in order. As shown in FIG. 5, the diaphragm 5 is pressed on one opening of the through hole 4 in the pressure introduction housing 1 by using the plate 6, and the diaphragm 5 and the plate 6 are laser-welded hermetically to the housing 1. In this manner, the through hole 4 is blocked by the diaphragm 5. The pressure introduction housing 1 is caulked to the connector side housing 10 with the oil 17 sealed therebetween. The cable cores 24 of the lead wires 23a, 23b and 23c extending through the grommet 22 are connected to the contacts 25 (metal fittings) at their ends by caulking. The grommet 22 is inserted in the connector side housing 10. The pins 11a, 11b and 11c are inserted in the holes 25a of the contacts 25 when the grommet is inserted in the housing 10. The pins 11a, 11b and 11c are soldered to the contacts 25 by using the solder 26.

The bridge circuit described above is inspected by an inspection signal supplied to the pin 11d. The output of from the sensor is inspected by monitoring an amplified output signal from the sensor.

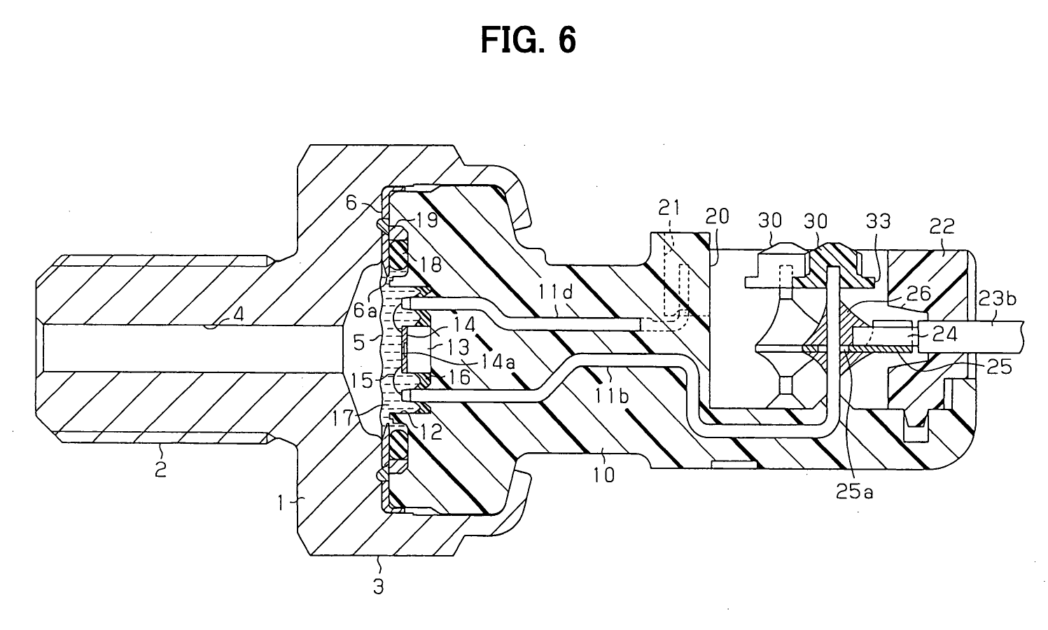

Next, as shown in FIG. 6, each end of the pins 11a, 11b and 11c is press-fitted in the cap member 30. The ends of the pins 11a, 11b and 11c are covered by the cap members 30.

Then, the connection space 20 of the connector side housing 10 is filled with the insulation 27. The insulation 27 is hardened to seal the connection space 20. The insulation 27 is poured into the connection space 20 and left at the temperature 125° C. for one hour to be hardened when the insulation 27 is made of epoxy. The insulation 27 fills the connection space 20 to a height that at least covers part of the concavities and convexities 32 on the cap member 30. The concavities and convexities 32 along with the flange 33 contribute to sealing when they are covered by the insulation 27.

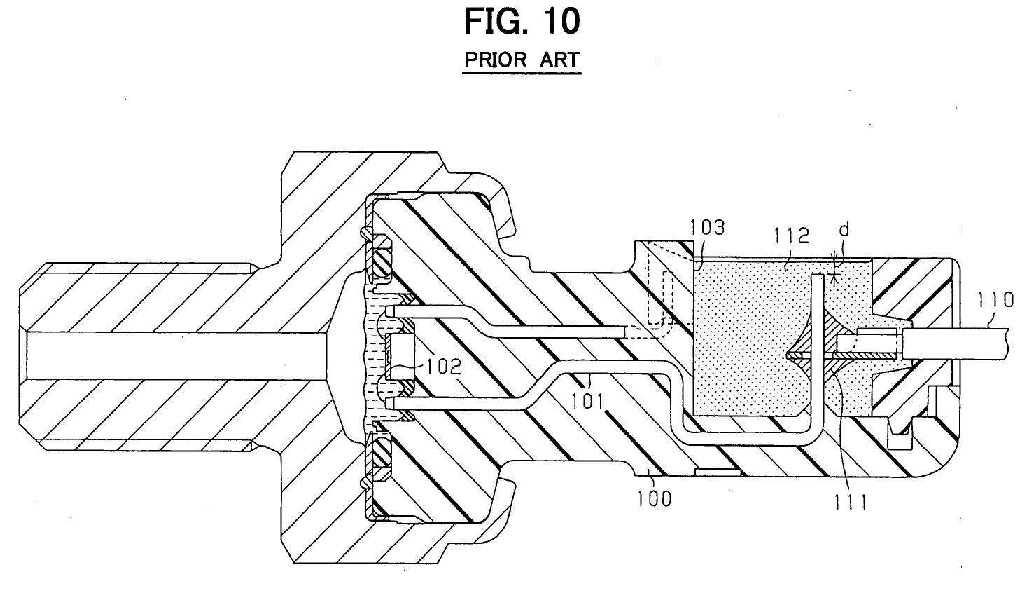

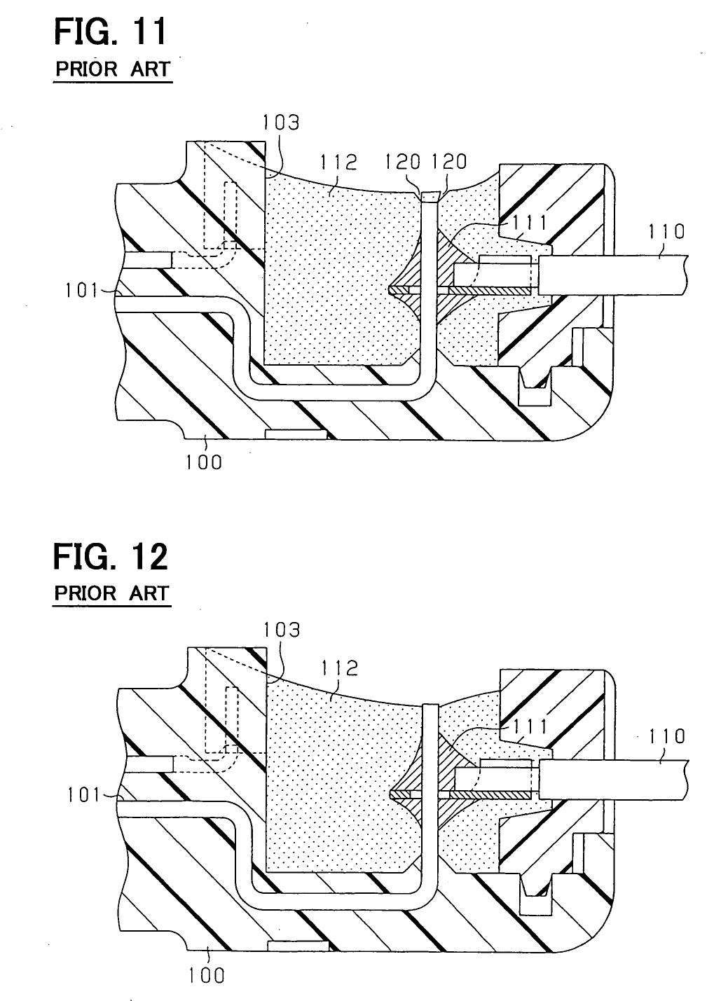

The pressure sensor manufactured in this manner has an increased tightness of sealing for the pins 11a, 11b and 11c covered by the cap member 30 and securely protects the pins 11a, 11b and 11c from external disturbance. That is, the pins 11a, 11b and 11c are prevented from being exposed by the cap members 30 as shown in FIG. 1 even when thickness d of the insulation 27 shown in FIG. 10 is not sufficient to prevent the insulation from having cracks by iterated heat stress. The exposure of the pins 11a, 11b and 11c caused by an insufficient amount of the insulation 27 as shown in FIG. 12 can also be prevented by the cap member 30. As a result, the pins 11a, 11b and 11c are securely protected from external water, and thus leakage of electric current, malfunction of the sensor and corrosion of internal parts are prevented.

The characteristics of the first embodiment of the present invention are summarized in the following.

(1) In a sealing structure of the housing 10, the pins 11a, 11b and 11c are covered by the cap members 30 at their ends that extend upward in the connection space 20 as shown in FIG. 1. Therefore, the pins 11a, 11b and 11c are securely protected from external disturbance such as water by the cap members 30 even when the insulation 27 is damaged by aging or insufficiency of the insulation 27. The pins 11a, 11b and 11c are otherwise exposed to the atmosphere.

(2) The cap members 30 can easily be put on the ends of the pins 11a, 11b and 11c. Therefore, the pins 11a, 11b and 11c can easily be covered and insulated.

(3) The concavities and convexities 32 on the outer surface of the cap member 30 can extend a contact area of the insulation 27 on the cap member 30 as shown in FIGS. 3 and 4. Therefore, the cap member 30 can be firmly held by the insulation 27.

(4) The flange 33 on the outer surface of the cap member 30 can firmly hold the cap member 30 in the insulation 27 as shown in FIGS. 3 and 4. Therefore, the cap member 30 is prevented from falling out of the insulation 27.

Although the present invention has been fully described in connection with the preferred embodiments thereof with reference to the accompanying drawings, it is to be noted that various changes and modifications will become apparent to those skilled in the art.

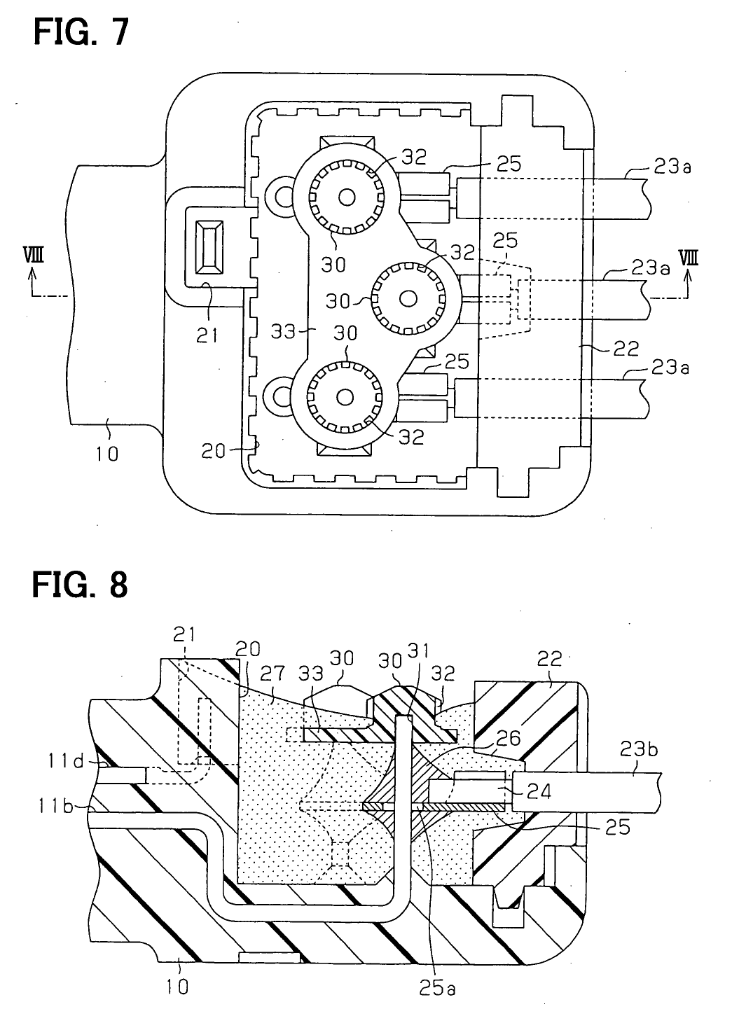

For example, the cap member 30 covers each end of the pins 11a, 11b and 11c separately in the first embodiment. However, the cap member 30 may cover all the ends of the pins in the connection space 20 by one body as shown in FIGS. 7 and 8. FIG. 7 shows an alternative form of the cap member 30 shown in FIG. 2. The insulation 27 is omitted in FIG. 7. FIG. 8 shows a vertical cross-section along VIII-VIII line in FIG. 7.

The pins 11a, 11b and 11c in FIGS. 7 and 8 are covered by the cap member 30 formed in one body. More practically, the flanges 33 of the cap members 30 are connected to form an integrated cap member 30 as shown in FIGS. 7, and 8.

The integrated cap member 30 has an increased operability. That is, the pins 11a, 11b and 11c protruding in the connection space 20 can more easily be covered by the integrated cap member 30 than covered by the three separate cap members 30.

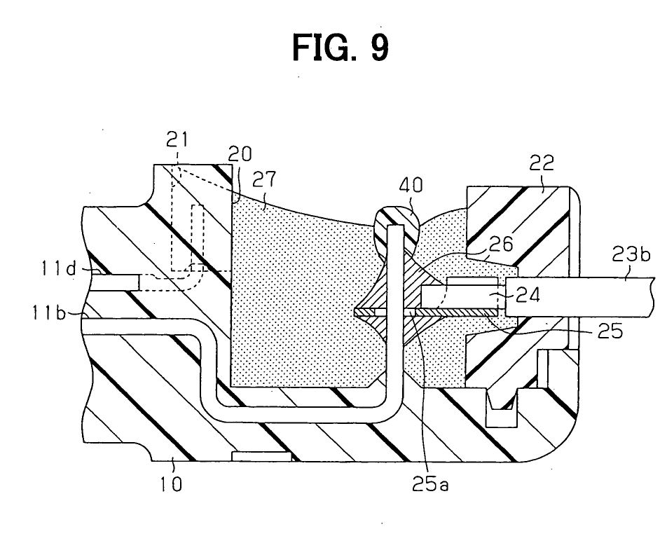

The cap member 30 for insulation may be replaced with a coating 40 as shown in FIG. 9. The coating 40 can easily be put on the pins 11a, 11b and 11c. Material used for the coating 40 may preferably have a similar thermal expansion coefficient to the insulation 27. Closeness of the thermal expansion coefficient contributes to the tightness of sealing.

The coating 40 may be replaced with a resin material such as poly-paraxylylene that can be deposited on the pins 11a, 11b and 11c and other parts in the connection space 20 by using a vacuum chamber.

The pins 11a, 11b and 11c in the connection space 20 extend vertically upward in the first embodiment. However, the pins 11a, 11b and 11c may be covered by an insulating material when they extend slantingly upward in the connection space 20.

The concavities and convexities 32 along with the flange 33 are formed on the cap member 30 as shown in FIGS. 3 and 4. However, the cap member 30 may only have the concavities and convexities 32, or may only have the flange 33.

Description of the embodiment so far refers to a sealing structure of terminals applied to a pressure sensor. However, the sealing structure may be applied to an acceleration sensor, a temperature sensor or the like. This structure may also be applied to an electric device other than a sensor.

Such changes and modifications are to be understood as being within the scope of the present invention as defined by the appended claims.

1. A connector having insulation for electrical connection comprising:
a housing having a concave portion;
a terminal extending through the housing;
a lead wire electrically coupled with the terminal;
a potting material for sealing the concave portion; and
an insulation material,
wherein the insulation material in contact with the potting material covers an end of the terminal extending upward in the concave portion.

2. The connector of claim 1,
wherein the insulation material is a cap member that covers the end of the terminal.

3. The connector of claim 2,
wherein the cap member has a concavity and a convexity on an outer circumferential surface.

4. The connector of claim 3,
wherein the cap member has a protruding portion on the outer circumferential surface.

5. The connector of claim 1,
wherein a plurality of the terminals are disposed in the concave portion, and
wherein the plural ends of the terminals are covered by a cap member having an integrated form of cap members.

6. The connector of claim 1,
wherein the insulation material is a coating.
